(19) United States
(12) Patent Application Publication
(10) Pub. No.: US 2006/0221529 A1
(43) Pub. Date: Oct. 5, 2006

(54) Power supply apparatus

(76) Inventors: Jin-ha Kim, Seongnam-si (KR); Joong-gi Kwon, Gunpo-si (KR)

Correspondence Address: STANZIONE & KIM, LLP, 919 18TH STREET, N.W., SUITE 440, WASHINGTON, DC, 20006, US

(21) Appl. No.: 11/368,642

(22) Filed: Mar. 7, 2006

(30) Foreign Application Priority Data
Mar. 31, 2005 (KR) 2005-26897

(51) Int. Cl. H02H 5/04

(52) U.S. Cl. 361/103

(57) ABSTRACT

A power supply apparatus includes a power converting unit to convert an AC power input by a power input unit and to supply the AC power to a heating unit, a relay interposed between the power input unit and the power converting unit to prevent supplying the AC power to the power converting unit, an auxiliary power unit to supply a driving power to the relay, and a power interruption unit to prevent supplying the driving power to the relay when the fusing roller is heated over a predetermined temperature. Accordingly, a power capacity required for a thermal switch is significantly lower than when the thermal switch is connected to the heating unit in series, so a thermal switch having low capacity may be used and manufacturing costs may be reduced. Since the AC power supplied from the power input unit to the power converting unit is completely interrupted, an unnecessary power consumption generated in the power converting unit by quiescent power is prevented.

### CROSS-REFERENCE TO RELATED APPLICATIONS

This application claims the benefit under 35 U.S.C. § 119 of Korean Patent Application No. 2005-26897 filed on Mar. 31, 2005 in the Korean Intellectual Property Office, the entire content of which is incorporated herein by reference.

### BACKGROUND OF THE INVENTION

1. Field of the Invention

The present general inventive concept relates to a power supply apparatus, and, more particularly, to a power supply apparatus to supply high frequency AC power to a heating unit, which heats a fusing roller of a fusing device in an image forming apparatus, so as to heat the heating unit to a predetermined temperature.

2. Description of the Related Art

Generally, an image forming apparatus, such as an electro-photographic printer, includes a photosensitive medium, a developing device, an imprinting device and a fusing device. The imprinting device transfers an image developed on the photosensitive medium with a developing agent provided by the developing device, to a recording paper, and the fusing device fuses the transferred image on the recording paper. A common fusing device having a fusing roller separately installed from an imprinting roller is configured to be capable of heating a surface of the fusing roller to a predetermined temperature so that a recording paper fed by the imprinting roller may be pressed and heated while moving in contact with the fusing roller. A heater lamp or an e-coil is generally included in the fusing device as a heating body for heating the surface of the fusing roller to the predetermined temperature.

FIG. 1 schematically illustrates a conventional power supply apparatus that supplies power to a halogen lamp inserted into a conventional fusing roller.

Referring to FIG. 1, a heating body 50 such as a halogen lamp, which is inserted into a fusing roller 30, is conventionally heated using an AC power supply 10, and a triac 20 is connected between the AC power supply 10 and the heating body 50.

The triac 20 is turned on or off by a controller (not shown) for controlling an electric connection between the heating body 50 and the AC power supply 10. The controller measures temperature of the heating body 50 or the fusing roller 30 using a sensor (not shown), and then controls the fusing roller 30 to have a predetermined temperature by turning on or off the triac 20 based on the measured temperature.

In addition, the conventional power supply apparatus has a thermal switch 40 connected in series between the triac 20 and the heating body 50 and arranged adjacent to the fusing roller 30 to interrupt the power to the heating body 50 when a temperature of the fusing roller 30 exceeds the predetermined temperature due to malfunction or out-of-control functioning of the controller. The thermal switch 40 is electrically opened to interrupt supply of power to the heating body 50 when the fusing roller 30 is overheated.

However, in the conventional power supply apparatus of FIG. 1 in which the thermal switch 40 is connected in series between the AC power supply 10 and the heating body 50, the thermal switch 40 should have a power capacity corresponding to the power supplied to the heating body 50.

In particular, when a heating operation is performed using a large high frequency current, the power supplied to the heating body 50 is significantly increased, so that a power capacity of the thermal switch 40 should be significantly increased accordingly, which causes an increase of manufacturing costs.

In addition, when the heating operation is performed using the large high frequency current, a lot of heat is generated in a connection device, such as the thermal switch 40, due to a high frequency power, and therefore it is harder to control the AC power supply 10 to heat the heating body 50 reliably.

### SUMMARY OF THE INVENTION

The present general inventive concept provides a reliable power supply apparatus requiring low manufacturing costs by using a thermal switch of a low capacity.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a power supply apparatus to supply an AC power input through a power input unit to a heating unit that heats a fusing roller, the apparatus including a power converting unit to convert the AC power input through the power input unit into a high frequency AC power and to supply the high frequency AC power to a heating unit, a relay interposed between the power input unit and the power converting unit to prevent supplying the AC power to the power converting unit, an auxiliary power unit to supply a driving power to the relay, and a power interruption unit to prevent supplying the driving power to the relay when the fusing roller is heated above a predetermined temperature.

the power interruption unit may include at least one thermal switch that is interposed between the relay and the auxiliary power unit and is electrically opened when the fusing roller is heated over the predetermined temperature.

The at least one thermal switch may be electrically connected in series between the relay and the auxiliary power unit.

The power converting unit may include a rectifier to rectify the AC power applied to the power input unit and to generate DC power, and a high frequency current generator to convert the rectified DC power into the high frequency AC power.

The power supply apparatus may further include a controller to control a magnitude of the high frequency AC power supplied from the power converting unit to the heating unit based on a temperature of the fusing roller.

The foregoing and/or other aspects of the present general inventive concept are also achieved by providing a power supply apparatus to supply an AC power, input through an power input unit, to a heating unit that heats a fusing roller, the apparatus including a rectifier to rectify the AC power input through the power input unit to generate a DC power, a high frequency current generator to convert the rectified AC power into a high frequency AC power and to supply the high frequency AC power to the heating unit, a relay interposed between the rectifier and the high frequency current generator to interrupt the rectified DC power supplied to the high frequency current generator, an auxiliary power unit to supply a driving power to the relay, and a power interruption unit to interrupt the driving power supplied to the relay when the fusing roller is heated over a predetermined temperature.

The power interruption unit may include at least one thermal switch that is interposed between the relay and the auxiliary power unit and is electrically opened when the fusing roller is overheated over a predetermined temperature.

The at least one thermal switch may be electrically connected in series between the relay and the auxiliary power unit.

The power supply apparatus may further include a controller to control a magnitude of the high frequency AC power supplied from the high frequency current generator to the heating unit based on a temperature of the fusing roller.

The foregoing and/or other aspects of the present general inventive concept are also achieved by providing a power supply apparatus to provide power to a heating unit usable with an image forming apparatus, the apparatus including a main electrical circuit to supply power to a heating unit and including a relay, and an auxiliary electrical circuit including a thermal switch to provide auxiliary low power to the relay to close the main circuit, the thermal switch opening the auxiliary circuit when a temperature of the heating unit is above a predetermined temperature.

The foregoing and/or other aspects of the present general inventive concept are also achieved by providing an image forming apparatus including a power supply apparatus to provide power to a heating unit having a main electrical circuit to supply power to a heating unit and including a relay, and an auxiliary electrical circuit including a thermal switch to provide auxiliary low power to the relay to close the main circuit, the thermal switch opening the auxiliary circuit when a temperature of the heating unit is above the predetermined temperature.

The foregoing and/or other aspects of the present general inventive concept are also achieved by providing a power supply usable with an image forming apparatus to provide power to a heating unit, the power supply including a high power circuit to supply power to a high power unit and including a relay, and a low power circuit to provide auxiliary low power to the relay to close the main circuit, when a predetermined condition is satisfied.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional power supply apparatus for supplying power to a halogen lamp inserted into a fusing roller;

FIG. 2 is a block diagram illustrating a power supply apparatus according to an embodiment of the present general inventive concept;

FIG. 3 is a block diagram illustrating a power supply apparatus according to another embodiment of the present general inventive concept; and

FIG. 4 is a block diagram illustrating a power supply apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

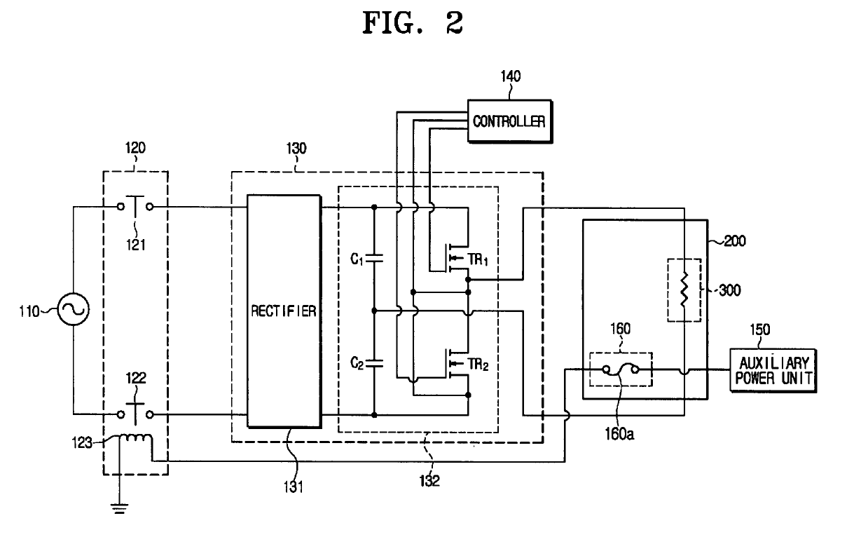

FIG. 2 is a block diagram illustrating a power supply apparatus according to an embodiment of the present general inventive concept.

Referring to FIG. 2, the power supply apparatus includes a power input unit 110, a relay 120, a power converting unit 130, a controller 140, an auxiliary power unit 150 and a power interruption unit 160.

The power input unit 110 may be a common power cord, which receives a common AC power having a voltage of 110/220V and a frequency of 60 Hz, and supplies the common AC power to the power converting unit 130.

The power converting unit 130 receives the common AC power from the power input unit 110, converts the common AC power into a high frequency AC power having a frequency of about 70 kHz-250 kHz required to perform heating, and supplies the high frequency AC power to a heating unit 300. In addition, the power converting unit 130 increases a magnitude of an input current about 2 or 3 times and then outputs the increased current. More specifically, the power converting unit 130 includes a rectifier 131 and a high frequency current generator 132.

The rectifier 131 rectifies the AC power input through the power input unit 110 to generate DC power, and the rectifier 131 may comprise a common bridge diode circuit having four diodes.

The high frequency current generator 132 receives the DC power generated by the rectifier 131 to generate high frequency AC power having a predetermined frequency, and then the high frequency current generator 132 supplies the high frequency AC power to the heating unit 300. The high frequency current generator 132 includes two capacitors C1 and C2 and two transistors TR1 and TR2, and generates a high frequency AC power by performing a switching operation of the transistors TR1 and TR2 that are alternately turned on or off according to a control signal input from the controller 140. In the present embodiment, the transistors TR1 and TR2 may comprise field effect transistors, but the present general inventive concept is not intended to be limited to using field effect transistors.

The controller 140 controls the switching operation of the transistors TR1 and TR2 according to a temperature measured by a sensor (not shown) that measures the temperature of a fusing roller 200. Consequently, the controller 140 controls a magnitude of the high frequency AC power supplied from the high frequency current generator 132 to the heating unit 300, thereby controlling the fusing roller 200 to be kept at a predetermined temperature.

The heating unit 300 generates heat using the high frequency AC power input from the high frequency current generator 132, and may be installed in the fusing roller 200 so as to heat a surface of the fusing roller 200 to the predetermined temperature. The heating unit 300 may include a halogen lamp or an e-coil.

The relay 120 is installed between the power input unit 110 and the power converting unit 130 to interrupt the supply of common AC power input from the power input unit 110 to the power converting unit 130.

More specifically, the relay 120 is configured with a relay coil 123 and relay contact points 121 and 122. In the present embodiment, the relay 120 receives a driving power from the auxiliary power unit 150. When the driving power is supplied, the relay contact points 121 and 122 are connected due to an electric current flowing through the relay coil 123, while, when the driving power is interrupted, the relay contact points 121 and 122 are not connected.

The auxiliary power unit 150 applies a DC power of several volts to the relay coil 123 as the driving power to connect the relay contact points 121 and 122.

The power interruption unit 160 is interposed between the relay 120 and the auxiliary power unit 150. If the fusing roller 200 is heated above the predetermined temperature, the power interruption unit 160 is electrically opened to interrupt the driving power that is supplied from the auxiliary power unit 150 to the relay 120. The power interruption unit 160 may include a thermal switch 160a, such as a thermostat or a thermal fuse, that is electrically opened when a surrounding temperature is above a predetermined temperature.

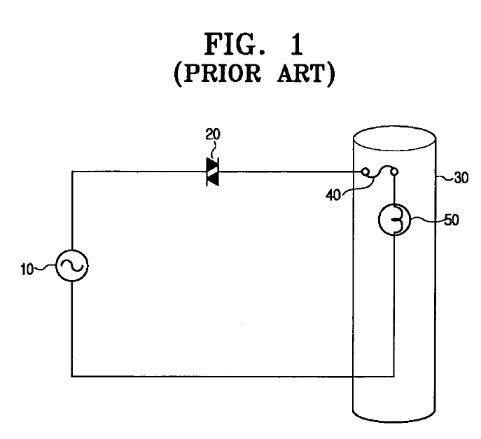

In the present embodiment, a current of several mili-Amperes (mA) flowing from auxiliary power unit 150 through the power interception unit 160 may be sufficient to drive the relay 120, which current is remarkably low as compared to a current of several tens of Amperes (A) flowing from the power converting unit 130 to the heating unit 300 that is interrupted if the relay does not receive the driving power. Thus, a power capacity required for the power interruption unit 160 is significantly lower when the power interruption unit 160 is connected between the auxiliary power unit 150 and the relay coil 123 of the relay 120 than when the power interruption unit 160 is connected in series with the heating unit 300 (as in a conventional power supply apparatus of FIG. 1). Accordingly, it is possible to reduce manufacturing costs by using a lower power capacity thermal switch.

In addition, if the relay contact points 121 and 122 are not connected, the AC power supplied from the power input unit 110 to the power converting unit 130 is completely interrupted, so it is possible to prevent an unnecessary power loss in the power converting unit 130 due to quiescent power.

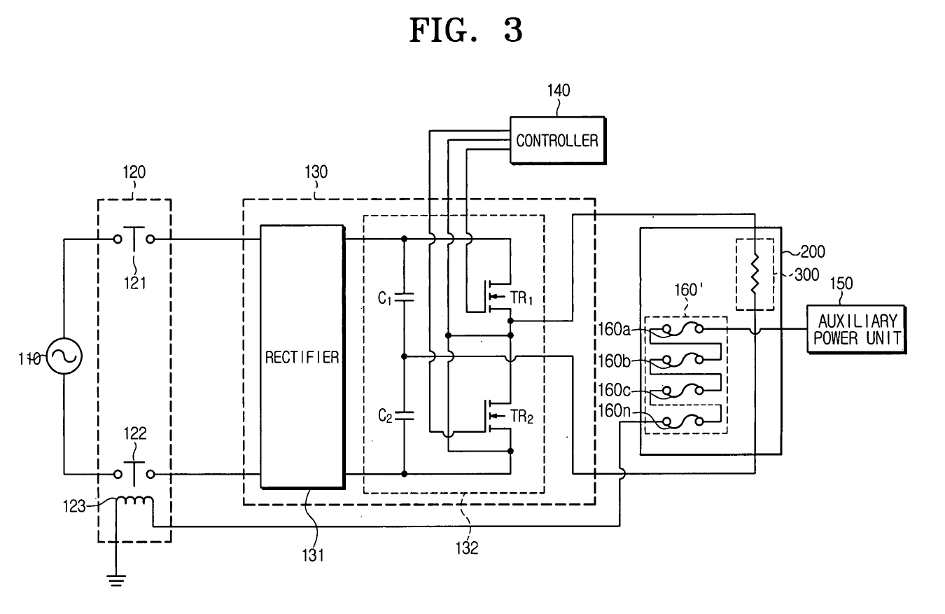

FIG. 3 is a block diagram illustrating a power supply apparatus according to another embodiment of the present general inventive concept. Some components of the power supply apparatus of FIG. 3 are similar to the components of the power supply apparatus of the previous embodiment. Accordingly, similar reference numbers are used to refer to these similar components.

Referring to FIG. 3, the power supply apparatus includes the power input unit 110, the relay 120, the power converting unit 130, the controller 140, the auxiliary power unit 150 and a power interruption unit 160′. In the present embodiment illustrated in FIG. 3, each component except the power interruption unit 160′ is the same as the respective component of the embodiment of FIG. 2. Thus, a detailed description of these components will not be provided here.

In the present embodiment, the power interruption unit 160′ includes N thermal switches 160a, 160b, 160c, . . . , and 160n connected in series between the auxiliary power unit 150 and the relay 120. When the fusing roller 200 is heated above a predetermined temperature, any of the N thermal switches is electrically opened, so that a driving power supplied from the auxiliary power unit 150 to the relay 120 is interrupted. Thus, the power interruption unit 160′ of the present embodiment may be operated at a higher sensitivity level as compared to the power interruption unit 160 of the previous embodiment illustrated in FIG. 2, which is configured with one thermal switch 160a.

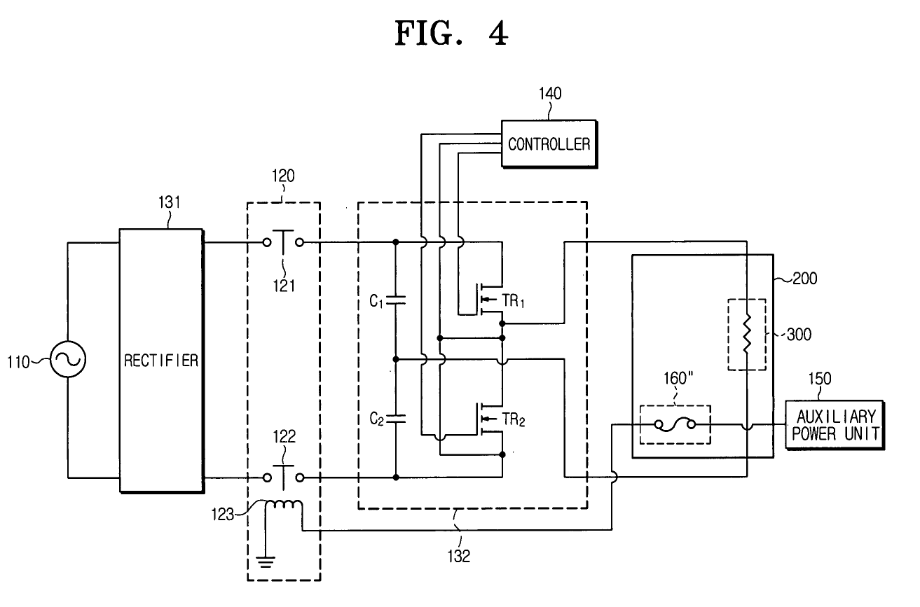

FIG. 4 is a block diagram illustrating a power supply apparatus according to another embodiment of the present general inventive concept. Some components of the power supply apparatus of FIG. 3 are similar to the components of the power supply apparatus of the previous embodiment. Accordingly, similar reference numbers are used to refer to these similar components.

Referring to FIG. 4, the power supply apparatus of the illustrated embodiment includes the power input unit 110, the relay 120, the rectifier 131, the high frequency current generator 132, the controller 140, the auxiliary power unit 150 and a power interruption unit 160″. In the present embodiment, the power input unit 110, the rectifier 131, the high frequency current generator 132, the controller 140 and the auxiliary power unit 150 operate the same as those of the embodiment described above with reference to FIG. 2. Thus, a detailed description of these components will not be provided here.

In the present embodiment, the relay 120 may be located between the rectifier 131 and the high frequency current generator 132. As in the embodiment illustrated in FIG. 2, when the fusing roller 200 is heated over a predetermined temperature, the power interruption unit 160″ installed adjacent to the fusing roller 200 is electrically opened. Accordingly, if a driving power supplied from the auxiliary power unit 150 to the relay 120 is interrupted, the relay 120 interrupts DC power rectified by the rectifier 131 so that the rectified DC power is not supplied to the high frequency current generator 132, thereby preventing the high frequency AC power from being supplied to the heating unit 300.

In addition, in the present embodiment, the power interruption unit 160″ may be realized using a plurality of thermal switches similar to the embodiment illustrated in FIG. 3.

As described above, in the present general inventive concept, since a power capacity required for the thermal switch is significantly lower than when the thermal switch is connected to a heating unit in series, a thermal switch having a low capacity may be used, thereby reducing manufacturing costs.

In addition, since the AC power supplied from the power input unit to the power converting unit is interrupted if the fusing roller is abnormally overheated and the relay is opened, it is possible to prevent unnecessary power consumption generated in the power converting unit by quiescent power.

In addition, since the power interruption unit is realized using a plurality of thermal switches, the high frequency AC power supplied to the heating unit may be interrupted at a higher sensitivity level when the fusing roller is overheated, compared to when one thermal switch is used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A power supply apparatus to supply an AC power, input through a power input unit, to a heating unit that heats a fusing roller, the apparatus comprising:
a power converting unit to convert the AC power input through the power input unit into a high frequency AC power and to supply the high frequency AC power to the heating unit;
a relay interposed between the power input unit and the power converting unit to interrupt the AC power supplied to the power converting unit when a driving power is not received;
an auxiliary power unit to supply the driving power to the relay; and
a power interruption unit to interrupt the driving power supplied to the relay when the fusing roller is heated above a predetermined temperature.

2. The power supply apparatus according to claim 1, wherein the power interruption unit comprises at least one thermal switch that is interposed between the relay and the auxiliary power unit and is electrically opened when the fusing roller is heated over the predetermined temperature.

3. The power supply apparatus according to claim 2, wherein the at least one thermal switch is electrically connected in series between the relay and the auxiliary power unit.

4. The power supply apparatus according to claim 1, wherein the power converting unit includes:
a rectifier to rectify the AC power applied to the power input unit and to generate a DC power; and
a high frequency current generator to convert the rectified DC power into the high frequency AC power.

5. The power supply apparatus according to claim 1, further comprising:
a controller to control a magnitude of the high frequency AC power supplied from the power converting unit to the heating unit based on a temperature of the fusing roller.

6. A power supply apparatus to supply an AC power, input through a power input unit, to a heating unit that heats a fusing roller, the apparatus comprising:
a rectifier to rectify the AC power input through the power input unit and to generate a DC power;
a high frequency current generator to convert the rectified AC power into a high frequency AC power and to supply the high frequency AC power to the heating unit;
a relay interposed between the rectifier and the high frequency current generator to interrupt the rectified DC power supplied to the high frequency current generator when a driving power is not received;
an auxiliary power unit to supply the driving power to the relay; and
a power interruption unit to interrupt the driving power supplied to the relay when the fusing roller is heated over a predetermined temperature.

7. The power supply apparatus according to claim 6, wherein the power interruption unit includes at least one thermal switch that is interposed between the relay and the auxiliary power unit and is electrically opened when the fusing roller is heated over a predetermined temperature.

8. The power supply apparatus according to claim 7, wherein the at least one thermal switch is electrically connected in series between the relay and the auxiliary power unit.

9. The power supply apparatus according to claim 6, further comprising:
a controller to control a magnitude of the high frequency AC power supplied from the high frequency current generator to the heating unit based on a temperature of the fusing roller.

10. A power supply apparatus usable with an image forming apparatus to provide power to a heating unit, the apparatus comprising:
a main electrical circuit to supply power to a heating unit and including a relay; and
an auxiliary electrical circuit including a thermal switch to provide an auxiliary power to the relay to close the main electrical circuit, the thermal switch opening the auxiliary electrical circuit when a temperature of the heating unit is above a predetermined temperature.

11. The power supply apparatus of claim 10, wherein the auxiliary power is lower than the power supplied by the main electrical circuit.

12. The power supply apparatus of claim 11, wherein the main electrical circuit further comprises:
an input power unit to input AC power;
a rectifier to convert the input AC power into DC power; and
a high frequency power generator, to convert the DC power into a high frequency AC power and to supply the high frequency AC power to the heating unit.

13. The power supply apparatus of claim 12, wherein the relay is disposed between the input power unit and the rectifier.

14. The power supply apparatus of claim 13, wherein the relay is disposed between the rectifier and the high frequency power generator.

15. The power supply apparatus of claim 10, wherein the main electrical circuit receives power from a first power supply, and the auxiliary electrical circuit receives power from a second power supply.

16. The power supply apparatus of claim 10, wherein an amount of current flowing in the main electrical circuit is substantially greater than an amount of current flowing through the auxiliary electrical circuit.

17. The power supply apparatus of claim 10, wherein an amount of current flowing in the main electrical circuit is at least 1000 times greater than an amount of current flowing through the auxiliary electrical circuit.

18. The power supply apparatus of claim 10, wherein the auxiliary electrical circuit comprises a plurality of thermal switches that open the auxiliary electrical circuit when the temperature of the heating unit is above the predetermined temperature.

19. The power supply apparatus of claim 10, wherein the main circuit comprises a controller to maintain the predetermined temperature in the heating unit by controlling a magnitude of a current in the main electrical circuit.

20. A power supply usable with an image forming apparatus to provide power to a heating unit, the power supply comprising:
a high power circuit to supply power to a high power unit and including a relay; and
a low power circuit to provide auxiliary low power to the relay to interrupt the supply of power from the high power circuit to the high power unit when a predetermined condition is satisfied.
